(19) United States
(12) Patent Application Publication
(10) Pub. No.: US 2023/0236950 A1
(43) Pub. Date: Jul. 27, 2023

(54) STATIC SOURCE CODE ANALYSIS USING EXPLICIT FEEDBACK AND IMPLICIT FEEDBACK

(71) Applicant: Perforce Software, Inc., Minneapolis, MN (US)

(72) Inventors: Rodney Cope, Bennett, CO (US); Jasmit Singh, Thornton, CO (US); Oliver Kalmend, Tallinn (EE); Kyle Harfoot, Bristol (GB)

(21) Appl. No.: 18/151,618

(22) Filed: Jan. 9, 2023

Related U.S. Application Data
(60) Provisional application No. 63/303,073, filed on Jan. 26, 2022.

(51) Int. Cl. G06F 11/36

(52) U.S. Cl. CPC G06F 11/3608; G06F 11/3616

(57) ABSTRACT

Techniques for performing an improved static code analysis are described. A computing device retrieves one or more source code files and metadata for each of the one or more source code files from storage components. The computing device identifies, using the model, one or more potential defects in a first source code file of the one or more source code files based at least in part on one or more of source code saved in the first source code file and metadata for the first source code file. The computing device receives both explicit feedback and implicit feedback for the one or more potential defects. The computing device updates the model with both the explicit feedback and the implicit feedback to develop an updated model.

### RELATED APPLICATION

This disclosure claims priority to U.S. provisional patent application No. 63/303,073, filed on Jan. 26, 2022, the contents of which are hereby incorporated by reference.

### TECHNICAL FIELD

The disclosure relates to source code debugging techniques.

### BACKGROUND

Software is made of intricate source code that, when compiled, read, and executed, cause a processor to perform certain functions based on the contents of the source code. During compiling and execution, errors are often found. The user must encounter the error, which often requires a specific path or set of inputs to encounter, note the area of the executed program where the error was encountered, and search through the source code, and hope to spot the portion of the potentially millions of lines of source code that includes the error.

Static code analysis is a process where either a user or an automated program cycles through the lines of source code and compare the lines of code to a set, or multiple sets, of rules in an attempt to flag potential errors in the source code without actually running the source code. This is generally a safer process, as some bugs, if encountered while the program is being executed, can be detrimental to the health of a computer. While static code analysis is safer, there are still limitations in the process. These rules typically have no understanding of developer intent, require understanding of external documentation, and can lead to a great number of false positives and false negatives through the analysis.

### SUMMARY

In general, the disclosure is directed to a system that utilizes a machine learning model to define the rules used in a static code analysis process. After performing the static code analysis process, the system receives both explicit feedback, such as the explicit identification of true positives, false positives, and false negatives, and implicit feedback, including metrics surrounding the correction of errors within the source code, and updates the machine learning model based on both the explicit and the implicit feedback.

The techniques described herein provide a number of benefits. By utilizing a machine learning model with both explicit and implicit feedback, the system is better able to provide a valid and relevant set of rules for a particular program, developer, developer group, overall company, or general industry. By providing an adaptive model that automatically configures itself to best analyze source code given the environment surrounding the source code, the techniques described herein solve a problem inherent to computers and improve the technology in and of itself by reducing the number of false positives and false negatives encountered during the static code analysis. Additionally, the techniques described herein are applied in a particularly meaningful way, using machine learning techniques to improve the particular area of static code analysis and improving the software debugging process for developers.

In one example, the disclosure is directed to a method including receiving, by one or more processors, one or more source code files and metadata for each of the one or more source code files. The method further includes identifying, by the one or more processors and using a model, one or more potential defects in a first source code file of the one or more source code files based at least in part on one or more of source code saved in the first source code file and metadata for the first source code file. The method also includes receiving, by the one or more processors, at least one of explicit feedback and implicit feedback (e.g., receiving, by the one or more processors, both of explicit feedback and implicit feedback) for the one or more potential defects. The method further includes updating, by the one or more processors, the model with both the explicit feedback and the implicit feedback to develop an updated model.

In another example, the disclosure is directed to a computing device that includes one or more storage components configured to store a model and one or more source code files. The computing device further includes one or more processors configured to retrieve the one or more source code files and metadata for each of the one or more source code files from the one or more storage components. The one or more processors are further configured to identify, using the model, one or more potential defects in a first source code file of the one or more source code files based at least in part on one or more of source code saved in the first source code file and metadata for the first source code file. The one or more processors are also configured to receive at least one of explicit feedback and implicit feedback (e.g., receive both of explicit feedback and implicit feedback) for the one or more potential defects. The one or more processors are further configured to update the model with both the explicit feedback and the implicit feedback to develop an updated model.

In another example, the disclosure is directed to a non-transitory computer-readable storage medium containing instructions. The instructions, when executed, cause one or more processors to receive one or more source code files and metadata for each of the one or more source code files. The instructions, when executed, further cause one or more processors to identify, using a model, one or more potential defects in a first source code file of the one or more source code files based at least in part on one or more of source code saved in the first source code file and metadata for the first source code file. The instructions, when executed, also cause one or more processors to receive at least one of explicit feedback and implicit feedback (e.g., receive both of explicit feedback and implicit feedback) for the one or more potential defects. The instructions, when executed, further cause one or more processors to update the model with both the explicit feedback and the implicit feedback to develop an updated model.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

The following drawings are illustrative of particular examples of the present invention and therefore do not limit the scope of the invention. The drawings are not necessarily to scale, though embodiments can include the scale illustrated, and are intended for use in conjunction with the explanations in the following detailed description wherein like reference characters denote like elements. Examples of the present invention will hereinafter be described in conjunction with the appended drawings.

FIG. 1 is a conceptual diagram illustrating an example computing environment and example interactions between entities in the computing environment to perform the improved static code analysis techniques described herein.

FIG. 2 is a block diagram illustrating a more detailed example of a computing device configured to perform the techniques described herein.

FIG. 3 is a flowchart illustrating an example method for performing the enhanced source code evaluation techniques described herein.

### DETAILED DESCRIPTION

The following detailed description is exemplary in nature and is not intended to limit the scope, applicability, or configuration of the invention in any way. Rather, the following description provides some practical illustrations for implementing examples of the present invention. Those skilled in the art will recognize that many of the noted examples have a variety of suitable alternatives.

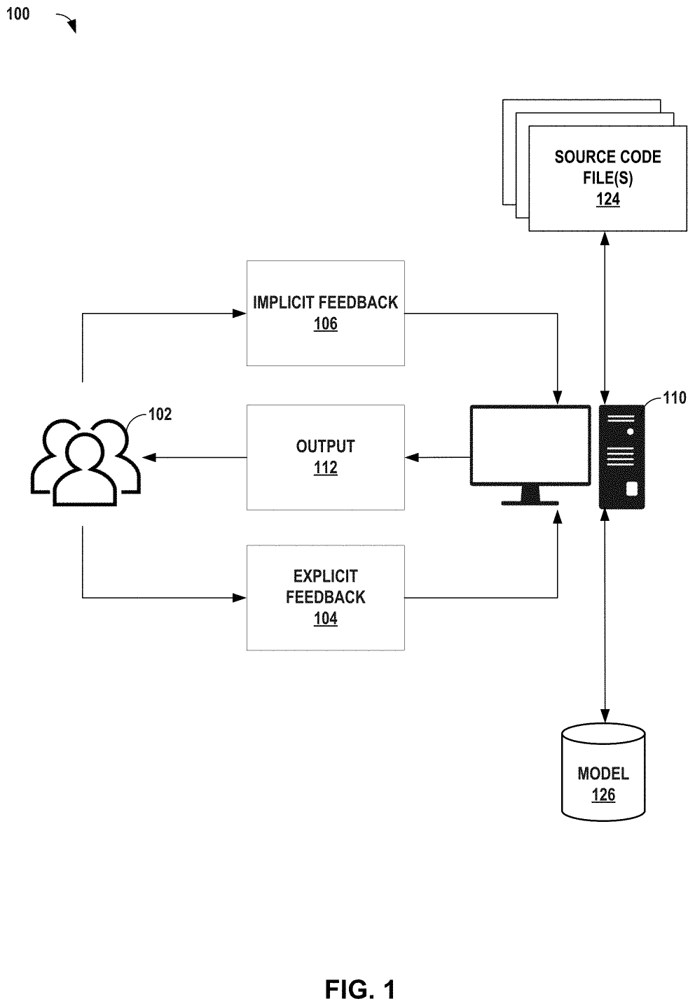

FIG. 1 is a conceptual diagram illustrating an example computing environment 100 and example interactions between entities in the computing environment 100 to perform the improved static code analysis techniques described herein. Computing environment 100 includes one or more users 102 operating computing device 110. Computing device 110 may store, or be in communication with an additional device that stores, one or more source code files 124 and model 126. Users 102 may provide input to computing device 110 for computing device 110 to analyze the source code within source code files 124 using model 126. Computing device 110 may provide, as output 112, one or more potential defects in the source code. Additionally or alternatively, output 112 may further include additional metrics or data regarding the source code within source code files 124. Users 102 may evaluate output 112 and provide explicit feedback 104 and/or implicit feedback 106 (e.g., provide at least one of explicit feedback 104 and/or implicit feedback 106, such as provide both of explicit feedback 104 and/or implicit feedback 106) back to computing device 110. Computing device 110 may receive explicit feedback 104 as explicit input received from users 102. Computing device 110 may receive implicit feedback 106 by monitoring behavior of users 102 when dealing with output 112 and the source code within source code files 124 and deriving implicit feedback 106 (e.g., from the user's behavior with respect to output 112 and the source code within source code files 124 and/or biographical information relating to the user). Computing device 110 may update model 126 using implicit feedback 106 and explicit feedback 104.

Computing device 110 may be any computer with the processing power required to adequately execute the techniques described herein. For instance, computing device 110 may be any one or more of a mobile computing device (e.g., a smartphone, a tablet computer, a laptop computer, etc.), a desktop computer, a smarthome component (e.g., a computerized appliance, a control panel for components, etc.), a wearable computing device (e.g., a smart watch, computerized glasses, smart headphones, etc.), a virtual reality/augmented reality/extended reality (VR/AR/XR) system, a server (e.g., a remote server system), or any other computerized device that may be configured to perform the techniques described herein.

The techniques described herein can provide static code analysis that checks not only that the syntax of source code is correct, but additionally that the code itself (e.g., function to be carried out as specified by the code) is correct. Using model 126, computing device 110 determines whether the source code will run, and also whether something may go wrong (e.g., executing the code may open a security hole or present a different quality issue). Additionally computing device 110 may determine whether multiple source code files may work together by updating model 126 based on method calls that may be located in different ones of source code files 124.

Currently, many static code analysis techniques can lead to false positives. It is complex to adequately identify potential defects without actually executing the code itself. As such, computing device 110 may continuously maintain model 126 so that any assumptions made during the static code analysis are informed assumptions to reduce the variability those assumptions may cause.

In some instances, model 126 may initially err on the side of caution and flag a potential bug. However, using explicit feedback 104 and implicit feedback 106, computing device 110 may update model 126 to hone in on the actual bugs present in code, learning to ignore bugs that have been determined to not, in fact, be bugs that the developer is concerned with. And, yet, flag with greater accuracy those bugs that the developer cares more about.

For instance, computing device 110 may update model 126 to include relative priorities of various bugs. While bugs that may crash the program when executed may intuitively be given high priorities, certain developers or certain industries may prioritize bugs in different ways. Computing device 110 may utilize explicit feedback 104 and implicit feedback 106 to determine those priorities specific to the particular developer and update model 126 to include those priorities.

Model 126 may include up to three or more levels of data. A first example of this data is actual usage data from developers and cited data, also referred to herein as explicit feedback 104. Explicit feedback 104 may include instances where a developer has gone through a list of bugs and created citations, such as from a dropdown menu (e.g., fix, defer to later, not a problem, etc.). Explicit feedback 104 may also include an indication that a developer used a developed list of defects and edited the source code to explicitly address these defects at the exact lines where those defects were predicted.

Explicit feedback 104 may also include additional defects that users 102 mark as needing to be fixed. Computing device 110 may analyze that explicit feedback to derive characteristics of the manually identified defect and update model 126 to find lines of source code with similar characteristics to the defect that is marked as needing to be fixed (e.g., written by same author, other functions that are similar, non-typical working hours time (e.g., writing code at 2:00 AM on a Saturday), etc.).

Explicit feedback 104 may also include “star factors,” or any number of metrics that could affect the quality of source code. For instance, these metrics could include how many times has this code been executed in this context, how many loops are present in the source code, and numerical inaccuracy, among other things. These metrics could also include data points such as file and/or method metrics (e.g., how big is this source code file, how many lines of code are present, how many characters are present, etc.), natural language processing (NLP) on trace info (e.g., stack and/or thread information from one line of code to the next executed line of code so that a human can better understand, at an natural language level, what is going on in the code, and comparing one defect to another), and defect code (e.g., an identified defect was given an explicit classification, such as an “array out of bounds” error).

Explicit feedback 104 may include any feedback provided by users 102 to explicitly indicate or cite the issue that users 102 would like to fix. Typically, computing device 110 presents users 102 with a set of potential issues in their code, and it is up to the user to decide which issues are important to fix for his or her project. Once the user has cited the issue to be fixed or not, computing device 110 may record metadata related to the cited issue and update model 126 with that information. In other words, explicit feedback 104 means that the user has explicitly provided some type of feedback regarding a potential defect.

As part of the issue management process, users may analyze each detected issue and assign status that indicates how it should be handled. This process is called “citing,” and is part of explicit data collection. Issue statuses may include (either explicitly or with other terminology describing a similar function) “Analyze (e.g., the defect should be reviewed, with all newly detected issues potentially displaying this status until a user changes the status), “Ignore” (e.g., intended for issues found (whether valid or otherwise) in code the user does not care about, for example, test code), “False Positive” (e.g., the issue reported is not valid and relates to an analysis failure), “Fix” (e.g., a valid issue that should be fixed as soon as possible), “Fix in Next Release” (e.g., a valid issue that is mostly harmless and can be left in the code base without too much risk, but should be addressed sooner rather than later), “Fix in Later Release” (e.g., a valid issue that is completely harmless and can be left in the code base indefinitely without risk), and “Defer” (e.g., a valid issue that needs discussion with others or escalation to, for example, a security team for final judgment).

A second example of data used by model 126 is non-cited data, or implicit feedback 106. One example of implicit feedback 106 may be if users 102 run, on computing device 110, a static code check at different times. Computing device 110 may determine if any defect went away in between those different executions (e.g., even though no explicit feedback was provided (e.g., flagged from a dropdown menu) for this defect). In this case, implicit feedback 106 may include that the developer fixed a defect because the defect went away. As such, computing device 110 may confirm that the identified defect was, in fact, a defect, and was also a defect that the developer cared about fixing. Furthermore, defects that went away faster may be more important to the developer, and computing device 110 may update model 126 to indicate that importance. Computing device 110 may also recognize a time of day that the defect was fixed, developer logs or comments discussing the identified defect, and other contextual information as implicit feedback 106 without requiring developer to do an extra work.

Other instances of implicit feedback 106 may include a developer's role on a team (e.g., a higher-ranking developer may address more important defects, while lower-ranking developers may address more benign defects), an author or developer's history (e.g., a developer that has a history of correcting difficult defects may be assigned to more complex and important defects), and bug tracking (e.g., a particular issue went away in between checks of the source code).

Implicit feedback 106 means that the user did not provide the feedback in a direct manner, but instead that computing device 110 analyzed metadata associated with the source code, the user codebase, and/or developer behavior to derive conclusions regarding identified defects and to prioritize issues in the code. In this way, computing device 110 “receiving” implicit feedback 106 may indicate that computing device 110 received indications of behavior surrounding the developer or the source code and analyzed the indications to derive implicit feedback 106. In other words, users may not intentionally provide any feedback on which issues they would like to fix. Rather, computing device 110 makes use of available data streams to collect and analyze data so that the conclusion derived from metadata associated with the source code, the user codebase, and/or developer behavior can be used as an input for updating model 126.

One example of implicit feedback 106 is an issue trace and defect message. This may include issues reported by static analysis tools that contain a call stack and a summarized message.

Another example of implicit feedback 106 is a source code metric. These metrics include metrics for both files and methods. For example, a metric could include the number of lines in a file, the complexity of a method, and the number of loop branches, among other metrics.

Another example of implicit feedback 106 is source and/or sink information. This information includes an indication of whether a method is a source or a sink and the number of sinks in a file/method, among other things.

Another example of implicit feedback 106 is a decision graph, which may include reasons and/or decisions for reporting a defect.

Another example of implicit feedback 106 is an Abstract Syntax Tree (AST). This may be a tree to represent the structure of program code.

Another example of implicit feedback 106 is environmental context. This context may include information such as compiler information, compiler warnings, and machine architecture, among other things.

Another example of implicit feedback 106 is the time elapsed to fix an issue. This may include a measure of the duration of time (e.g., a number of minutes, hours, or days) it took a developer to fix an issue.

Another example of implicit feedback 106 is a bug tracking/ticket system correlation. Certain systems may generate tickets for developers to fix bugs identified using the techniques described herein. The relationship between the reported issue and the bug tracking system may be used as implicit feedback 106.

Another example of implicit feedback 106 is a time for code review or comments. This data may include how long code was in the review process, how many comments were included on the code being reviewed, how many reviewers looked at the code, how many negative reviews the code received, and reviewer statistics (e.g., previous history of good/bad code), among other similar metrics.

Another example of implicit feedback 106 is user textual description. This description may include code comments, commit comments, bug tracking system description and comments, etc. (e.g., looking for concepts related to “crash”, “bug”, “complex”, “TODO”, etc.).

Another example of implicit feedback 106 is a coding “co-pilot” suggestion. Certain programs provide code suggestions as the developer enters the code into the program. These suggestions may be used as implicit feedback, indicating what should be present as compared to what is actually present.

Another example of implicit feedback 106 is a code author profile. This profile may include statistics on the author. For example, certain developers may develop a reputation for writing buggy and insecure code, while others may consistently write very clean code. Additional metrics could include how long an author has been on a project, whether the developer is new to a specific area of the code, etc.

Another example of implicit feedback 106 is a reported defect metric. This may include how often the static analysis generated defect code appears, how many instances of the defect are in the code base, a defect re-appearance rate (e.g., the defect appears in the same file or method), defects with the same root cause, and how many changes in the lifetime of the defect, among other metrics.

Another example of implicit feedback 106 is a code commits metric. This may include a number of lines of code changed related to the defect, a relative number of commits between the defect appearance and the fix, a day or time of the commit, comment, or fix, (e.g., whether it's at a non-typical working time, such as Saturday at 2:00 AM could indicate bad code), rapid or small commits to the same code areas, commit rate a time close to a deadline, and commits outside of normal working hours, among other things.

Another example of implicit feedback 106 is user behavior data. This may include issues cited by the user for their specific project, while also include issues that are not cited but still acted upon (e.g., converting implicit action to explicit feedback). Computing device 110 may create profiles for Industry-specific, user-specific, project-specific, codebase-specific, code area-specific, and/or project intention-specific (e.g., compliance, quality, security) areas.

Another example of implicit feedback 106 is the source code itself. Using artificial intelligence or other methods, computing device 110 may read the actual source code related to a defect to determine if the source code looks problematic. Computing device 110 may then determine if an automatic code development algorithm would generate the same code. Computing device 110 may also look for similar code in an open source code base or in places where source code is available and known to be correct.

A third example of data used by model 126 may include online data. Online data may include recommendations that certain developers with similar characteristics (e.g., certain levels of experience, titles, or industries) did a particular action with their code, meaning the user may wish to do a similar action. For instance, different industries (e.g., automotive, medical device, defense industry) may have different expectations for their software. It may be an industry where it is desirable to have no errors, even at the expense of slower times to market, whereas, in other industries, it may be desirable to get to market quick, even with some minor defects. Furthermore, it could be project-specific within an industry as to how important it is to be defect-free (e.g., in the automobile industry, it may be more important for a brake system to be defect free than it is for an entertainment system to be defect free).

Online data may refer to data that is used by model 126 but is generated by other users. This form of data may create a user feedback loop or incorporate user behavior into model 126.

The notion of explicit and implicit data collection also applies to online data. For example, users may indicate which issues they want to fix in real-time or their interaction with the static analysis tool may be recorded to gauge the importance of an issue. When initializing model 126, computing device 110 may initialize model 126 with a “cold start,” using similar data of others in similar industries. For instance, computing device 110 may use a questionnaire (e.g., what industry, level of experience of developer, programming language, etc.) to initially create model 126.

Model 126 may include a weight for a variety of factors for source code, weighing each of the factors in a dynamic manner. The weights of specific factors may depend on context (e.g., industry, etc.).

In some instances, computing device 110 may produce additional output 112. Output 112 may include defect rankings (e.g., a listing from the top defect a user must fix to least important defects), whether a defect is a false or true positive, an enhanced user experience with real time rankings that account for user behavior (e.g., as users interact/cite issues, rankings will improve over time), similar issues according to user profile, industry profile, codebase profile, or project profile (e.g., compliance, quality, security), overall project quality (e.g., likelihood of success/failure in a period of time), release quality, developer ranking, developer value (e.g., quality or productivity relative to quality), an estimated time to fix all of the remaining defects, a time to fix the most important defects according to the defect rankings, a development team strength, a development cost for code, a maintenance cost for the code base, an estimate of a code base's final product's end user feedback on quality, an estimate of developer happiness (as well as their spouse, family, friends, etc.), an estimate of company revenue and other success metrics, and an estimate of developer salary.

Computing device 110 may update model 126 in various ways. Updates may be either public (e.g., named) or private (e.g., anonymous). Computing device 110 may also update model 126 in real-time or in a batch process. Computing device 110 may also obfuscate project information.

In some examples users 102 may be required to opt in to have implicit feedback 106 monitored and derived. For instance, throughout the disclosure, examples are described where a computing device and/or a computing system may analyze information associated with a computing device or user behavior only if the computing device receives permission from the user to analyze the information. For example, in situations discussed below in which the computing device may collect or may make use of information associated with the user, the user may be provided with an opportunity to provide input to control whether programs or features of the computing device can collect and make use of user information, or to dictate whether and/or how to the computing device may receive content that may be relevant to the user. In addition, certain data may be treated in one or more ways before it is stored or used by the computing device and/or computing system, so that personally-identifiable information is removed. For example, a user's identity may be treated so that no personally identifiable information can be determined about the user, or a user's geographic location may be generalized where location information is obtained (such as to a city, ZIP code, or state level), so that a particular location of a user cannot be determined. Thus, the user may have control over how information is collected about the user and used by the computing device.

Computing device 110 may also utilize a voting or ensemble approach with model 126. For instance, model 126 may include multiple algorithms voting on the most important defects. Computing device 110 may also utilize context-sensitive blending (e.g., type of codebase, industry, compliance vs. quality, user behavior & history, etc.).

Features in model 126 have been chosen to reflect the characteristics of a defect found by static analysis. The features may be discriminating and informative characteristics in deciding the importance of defects to the end-user. The features can be separated into code analysis engine, file, and method metrics. In addition, computing device 110 may utilize defect codes output by the static analysis engine, as the codes may also contain discriminating information about the importance of a defect.

One example of a code analysis engine metric includes “TotalBranches.” This is a control flow graph (CFG) metric. This metric states the number of branches (i.e., decision points) in the CFG encountered during the propagation from the source of the defect to the sink. It is not an inaccuracy metric by itself, but it is normally used in combination with other information.

Another example of a code analysis engine metric includes “loopBranches.” This is a control flow graph (CFG) metric. It states the number of loop branches (loop heads and weird cases of loops like while loops with gotos in the middle) in the CFG encountered during the propagation from the source to the sink. It is an inaccuracy metric since our propagation algorithm needs to abstract (create inaccuracies) when dealing with loops.

Another example of a code analysis engine metric includes “noKnowledgeBranches.” This is a control flow graph (CFG) metric coupled with information about the memory state at the beginning of each branch. It states the number of symbolic expressions that are unknown within the memory state at the beginning of all branches (decision point) in the CFG encountered during the propagation from the source to the sink. It is an inaccuracy metric since it explains how many expressions are not known when starting to evaluate data.

Another example of a code analysis engine metric includes “inaccurateBranchDecisions.” This is a control flow graph (CFG) metric coupled with information about the memory state at the beginning of each branch and the numeric range inaccuracies. It is an accumulator of the number of inaccurate predecessors (and self) for the numeric ranges for each symbolic polynomial constraints within the memory state at the beginning of all branches (decision point) in the CFG encountered during the propagation from the source to the sink. It also includes the number of inaccurate predecessors (and self) when evaluating numerically the symbolic polynomials that we have knowledge for within the memory state. It is an inaccuracy metric since it explains how much inaccuracy was introduced by our abstract numeric calculations when starting to evaluate data at branch point.

Another example of a code analysis engine metric includes “callWithInaccurateSideEffect.” This is a metric about the inaccuracies introduced during calls in the current function encountered during the propagation from the source to the sink.

Another example of a code analysis engine metric includes “numericInaccuracy.” This is a metric about the inaccuracies introduced by the memory item that is tracked during the propagation from the source to the sink. These inaccuracies are exactly the number of inaccurate predecessors (and self) found in the numeric range associated to the sink memory state for this memory item.

Another example of a code analysis engine metric includes “traceBlocksCounter.” This is a metric about the “complexity” of the defect. Simple defects tend to have a smaller trace. Thus, this metrics counts the number of trace blocks within the trace of the defect.

Another example of a code analysis engine metric includes “TraceCallsCounter.” This is a metric both about the “complexity” and “potential inaccuracy” of the defect. Each time a function is called in the trace, then it means that computing device 110 had to use the knowledge base (KB) associated to this function to resolve the call. Doing so introduces potential inaccuracy since KB records are an abstraction of the function behavior. This metrics is about counting the number of calls within the trace of the defect. (FB)KB is a Function Behavior Knowledge Base, or a record that describes analysis sensitive behavior of functions in an analyzed system.

Another example of a code analysis engine metric includes “MixingNumericAndSymbolic.” This metric is the count of mixed numeric and symbolic symbols the CFG encountered in the propagation from source to sink.

Another example of a code analysis engine metric includes “inaccurateTypeConversions.” This emtric is the count of inaccurate type conversion the CFG encountered in the propagation from source to sink.

In addition to using path checker metrics, computing device 110 and model 126 may use metrics that the static analysis engine has about the code, or file metrics. One example of a file metric is a number of lines of code in the file, possibly calculated as (last line number)−(first line number)+1.

Another example of a file metric includes a number of class declarations. This is a number of classes declared in a file at a global level (inner classes and their members are not included in this metric).

Another example of a file metric includes a number of constant declarations. This is a number of constant declarations that are declared in this file at a global level

Another example of a file metric includes a number of data items declared. This is a number of data items (outside of any classes) that are declared in this file at a global level.

Another example of a file metric includes a number of comment sections in a file. Another example of a file metric includes a number of bytes of comments in the file. Another example of a file metric includes a number of lines of code with comments. Another example of a file metric includes a number of macros defined in the file.

Another example of a file metric includes a number of local includes. This is a number of local includes, for example, #include “ . . . ”.

Another example of a file metric includes a number of system includes. This is a number of system includes, for example, #include < . . . >.

Another example of a file metric includes a number of third-party includes. This is a number of third-party include files (the number of includes, where the file name starts with a ‘/” or ‘../’.).

Another example of a file metric includes a number of include directives in a file. This is the total number of include directives in a file.

Another example of a file metric includes a number of functions and methods in a file. This is a number of class methods and functions met within a file.

Another example of a file metric includes a number of calls to other routines for all routines in the file. Another example of a file metric includes a number of conditional arcs for all routines in the file. Another example of a file metric includes a maximal conditional span for all routines in the file. Another example of a file metric includes a maximal value of control nesting for all routines in the file. Another example of a file metric includes a sum of logarithms of the numbers of independent paths for all routines in the file. Another example of a file metric includes a number of operands for all routines in the file.

Another example of a file metric includes a number of operators for all routines in the file. Another example of a file metric includes a Sum of McCabe Cyclomatic complexity metrics for all routines in the file. Another example of a file metric includes a number of control statements in the file. This is a sum of the number of control statements for all routines in a file

Another example of a file metric includes a number of data items declared local for all routines in the file. Another example of a file metric includes a number of executable statements for all routines in the file. This is a sum of the number of executable statements for all routines in a file

Another example of a file metric includes a number of lines of code for all routines in the file. Another example of a file metric includes a number of declarative statements for all routines in the file. This is a sum of the number of declarative statements for all routines in a file

Another example of a file metric includes a number of statements for all routines in the file. Another example of a file metric includes a complexity risk for the file. This is a complexity index metric that predicts the risk of fault insertion during modification or being inherent when created.

Another example of a file metric includes a number of occurrences of global variable usage for all routines in the file. This is a sum of the number of occurrences of global variable usages for all routines in a file

Another example of a file metric includes a number of methods for all classes of the file. This is a number of methods defined within classes for a file plus stand-alone methods in C++ from the same file

Another example of a file metric includes a number of ways a class can be accessed for all classes of the file. This is a number of protected, public and private methods where, in C++, the private methods are only counted if the class has friends.

Another example of a file metric includes the Halstead program volume metric for the file. Another example of a file metric includes a number of blank lines in the file. Another example of a file metric includes a number of compiler directives in the file. This is a number of compiler directives in the file. The directives counted are #if, #ifdef, #ifndef, #else, #endif, and #elif.

Another example of a file metric includes a number of Bytes of global variables declared in the file. Another example of a file metric includes a maximum level of include file nesting in the file, or the length of the longest include chain in the file.

Another example of a file metric includes a total number of included files called in the file. This is the total number of files that the preprocessor includes in a translation unit. Another example of a file metric includes a number of Non-comment, non-blank lines of code in the file. This is a the number of lines of code in a file, not including comment lines and blank lines.

Computing device 110 and model 126 may also include function, or method, metrics. One example of a method metric includes a number of lines of code in the method or function, sometimes calculated as (last line number)−(first line number)+1.

Another example of a method metric includes a number of operands used. An operand is an identifier or a constant. This metric calculates the total number of identifiers and constants used in the function or method. Note that a method name is also an identifier. For this metric, a function call is considered an operator.

Another example of a method metric includes a number of distinct operands used. This is a number of unique operands (variables and constants) used in the current function. Variables are distinguished by name, so usages of overridden variables do not contribute to this metric. Constants are distinguished by value, so all strings are assumed to be unique. For this metric, a function call is considered an operator.

Another example of a method metric includes a number of operators used. This is a number of operators used in the function or method. This metric counts the total number of accesses to variable, binary, ternary, unary, field access, index access, call, new instance of, expr-class, expression-this, and expression-super. All function calls are considered as operators.

Another example of a method metric includes a number of distinct operators used. This is a number of unique operators used in the function. Like NOOPRUSED, but function calls are considered as one unique operator. For example, Msg and printf function calls are counted only once.

Another example of a method metric includes a number of returns. This is a number of return statements in the function (not return points).

Another example of a method metric includes a cyclomatic complexity. This cyclomatic complexity (e.g., a McCabe Cyclomatic Complexity metric) shows the number of areas plane is divided by control flow graph

Another example of a method metric includes a number of independent paths. This metric calculates the natural logarithm of the number of independent paths through the function or method. A path is considered independent from a set of other paths if it cannot be expressed as a combination of that set paths' sub-paths. A function with an empty body has exactly one path through it.

Another example of a method metric includes a number of parameters, or arguments, in the function or method. Another example of a method metric includes a number of calls to unique functions. This is a number of calls from function or methods (for which metrics are calculated) to other functions or methods. Any number of calls to the same function or method may add only one to this metric.

Another example of a method metric includes a number of calls outside the class. This is a number of calls outside the class (number of calls to methods with a different “this”). For a method, this metric is equal to the total number of calls minus the number of calls to other methods of the same class (including self). For a function that is not a method, this metric is equal to the total number of calls.

Another example of a method metric includes a number of parameters passed to other functions. Another example of a method metric includes a number of executable statements and blank statements in the function or method. An executable statement is an operator such as a+=b; or a function call such as f(s+y, z).

Another example of a method metric includes a number of statements. This is a number of expression and control statements (if, for, while). This metric is the sum of NOCONTROLSTAT, NOEXSTAT, and NOMDECLSTAT for the function or method.

Another example of a method metric includes a number of loops. This is a number of for, while, and do-while statements in the current function.

Another example of a method metric includes a number of conditional statements. This is a number of if and switch statements in the current function.

Another example of a method metric includes a number of else and case statements. This is a number of else and case statements in the current function. Default statements are not included.

Another example of a method metric includes a maximum level of control nesting. This is a maximum level of nested control statements (if, switch, for, while, and do-while statements). The initial MAXLEVEL (for example, a function with no operators) is equal to 1.

Another example of a method metric includes an average level of control nesting. This is an average number of executable statements in a function or method; calculated as the sum of the level of each executable statement for all statements in the function divided by the number of executable statements. If the number of executable statements is 0, AVERLEVEL is 0.

Another example of a method metric includes a number of local declarations. This is a number of data items declared locally within the function.

Another example of a method metric includes a maximum number of executable statements in a conditional arc. This is a maximum number of executable statements located within the span of a branch of a conditional arc

Another example of a method metric includes a number of conditional arcs in the control graph of the function or method. This is a number of conditional branches in the control graph of the function or method (if, switch, do, while, or for statements).

Another example of a method metric includes a number of control statements in the function or method. This is a number of control statements (statements that operated control flow within a function or method). This metric calculates the number of loops or conditional statements (if, switch, do, while, for), plus the number of control-passing statements (return, break, continue, goto), plus the number of try-catch statements.

Another example of a method metric includes a number of declarative statements in the function or method. This is a number of declarative statements in the function or method; for example, the declaration of a local array or a local variable. This differs from NOLOCDECL because 1 declaration statement can declare several local variables.

Another example of a method metric includes a number of accesses to global variables. This is a number of accesses (e.g., reads and writes) to variables defined outside the function or method.

Another example of a method metric includes a number of bytes of local variables declared. Another example of a method metric includes a number of bytes of parameters for the function. Another example of a method metric includes a number of bytes of parameters passed to other functions. Another example of a method metric includes a number of calls to non-prototyped functions. Another example of a method metric includes a number of reads from global variables. Another example of a method metric includes a number of writes to global variables.

Another example of a method metric includes a number of non-comment, non-blank lines of code in the function or method. This is a number of lines of code in a function or method, not including comment lines and blank lines.

Another example of a method metric includes an extended cyclomatic complexity. Extended cyclomatic complexity includes logical Boolean operators in the decision count. Whenever a logical Boolean operator (&& or |) is encountered within a conditional statement, EXTCYCLOMATIC increases by one. The conditionals considered are: If, IfElse, While, DoWhile, For and Switch.

Another example of a method metric includes a plain cyclomatic complexity. This metric is like cyclomatic complexity (metric code 135), but is calculated on plain code (before preprocessor expansion). Any conditional statements generated from macro definitions do not result in PLAINCYCLOMATIC metric.

Another example of a method metric includes a number plain extended cyclomatic complexity. This is like extended cyclomatic complexity (metric code 164), but is calculated on plain code (before preprocessor expansion). Any conditional statements generated from macro definitions do not result in PLAINEXTCYCLOMATIC metric.

Computing device 110 may also produce certain defect codes. Each defect found by static analysis can be categorized and mapped to a code. This code can be used as part of the importance detection by feeding it into a machine learning algorithm. Codes represent the general type of defect. While the following include certain examples of potential defects and defect codes, it is understood that the techniques described herein can find additional defects and utilize additional codes for those defects, or may utilize different codes other than those listed below.

One example defect code is “MLK.MUST”, for a memory leak. This code means that the program did not release previously allocated memory and a reference to dynamic memory is lost causing a leak. Memory leaks cause the application to consume additional memory. This reduces the amount of memory available to other applications and eventually causes the operating system to start paging, slowing the system down. In critical cases, the application will reach overall memory limits, which may result in application crashes.

These kinds of leaks are critical because they affect the stability of the code and the system it is being run on. Our neural network will use the code to understand that the importance of a defect with this code. It is likely that it will have high importance due to the impact of memory leaks.

Another example defect code is “NPD.FUNC.MUST,” where it is possible a null pointer is dereferenced. This code represents an attempt to access data using a null pointer which causes a runtime error. When a program dereferences a pointer that is expected to be valid but turns out to be null, a null pointer dereference occurs. Null-pointer dereference defects often occur due to ineffective error handling or race conditions, and typically cause abnormal program termination.

Another example defect code is “ABV.GENERAL”, for a buffer overflow-array index out of bounds exception. A buffer overflow, or overrun, is an anomaly in which a program writing data to a buffer overruns the buffer's boundaries and overwrites adjacent memory. Typically, this problem occurs when a program is copying strings of characters to a buffer. Consequences of buffer overflow include valid data being overwritten and execution of arbitrary and potentially malicious code.

Another example defect code is “HCC.PWD”, or the use of hard-coded credentials (password). If software contains hard-coded credentials for authentication, the software is highly vulnerable to attacks because a malicious user has the opportunity to extract this information from the executable file. The use of hard-coded credentials makes it possible for an attacker to extract the credentials from the executable file and bypass the authentication. Hard-coded credentials create a significant risk that may be difficult to detect and to fix.

The techniques described herein provide a number of benefits. By utilizing a machine learning model with both explicit and implicit feedback, the system is better able to provide a valid and relevant set of rules for a particular program, developer, developer group, overall company, or general industry. By providing an adaptive model that automatically configures itself to best analyze source code given the environment surrounding the source code, the techniques described herein solve a problem inherent to computers and improve the technology in and of itself by reducing the number of false positives and false negatives encountered during the static code analysis. Additionally, the techniques described herein are applied in a particular meaningful way, using machine learning techniques to improve the particular area of static code analysis and improving the software debugging process for developers.

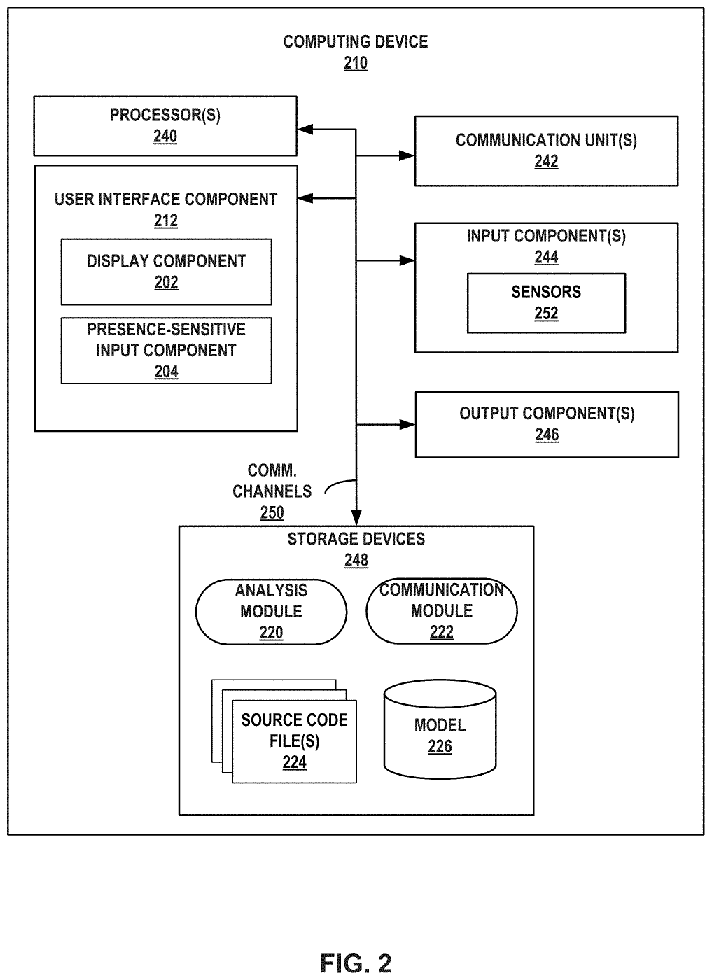

FIG. 2 is a block diagram illustrating a more detailed example of a computing device configured to perform the techniques described herein. Computing device 210 of FIG. 2 is described below as an example of computing device 110 of FIG. 1. FIG. 2 illustrates only one particular example of computing device 210, and many other examples of computing device 210 may be used in other instances and may include a subset of the components included in example computing device 210 or may include additional components not shown in FIG. 2.

Computing device 210 may be any computer with the processing power required to adequately execute the techniques described herein. For instance, computing device 210 may be any one or more of a mobile computing device (e.g., a smartphone, a tablet computer, a laptop computer, etc.), a desktop computer, a smarthome component (e.g., a computerized appliance, a home security system, a control panel for home components, a lighting system, a smart power outlet, etc.), a wearable computing device (e.g., a smart watch, computerized glasses, a heart monitor, a glucose monitor, smart headphones, etc.), a virtual reality/augmented reality/extended reality (VR/AR/XR) system, a video game or streaming system, a network modem, router, or server system, or any other computerized device that may be configured to perform the techniques described herein.

As shown in the example of FIG. 2, computing device 210 includes user interface component (UIC) 212, one or more processors 240, one or more communication units 242, one or more input components 244, one or more output components 246, and one or more storage components 248. UIC 212 includes display component 202 and presence-sensitive input component 204. Storage components 248 of computing device 210 include analysis module 220, communication module 222, one or more source code files 224, and notification data store 226.

One or more processors 240 may implement functionality and/or execute instructions associated with computing device 210 to maintain model 226 and perform code analysis on source code files 224. That is, processors 240 may implement functionality and/or execute instructions associated with computing device 210 to dynamically update model 226 based on feedback received from a user and utilize model 226 to analyze source code files 224.

Examples of processors 240 include application processors, display controllers, auxiliary processors, one or more sensor hubs, and any other hardware configured to function as a processor, a processing unit, or a processing device. Modules 220 and 222 may be operable by processors 240 to perform various actions, operations, or functions of computing device 210. For example, processors 240 of computing device 210 may retrieve and execute instructions stored by storage components 248 that cause processors 240 to perform the operations described with respect to modules 220 and 222. The instructions, when executed by processors 240, may cause computing device 210 to dynamically update model 226 based on feedback received from a user and utilize model 226 to analyze source code files 224.

Analysis module 220 may execute locally (e.g., at processors 240) to provide functions associated with analyzing source code files 224 and developing model 226. In some examples, analysis module 220 may act as an interface to a remote service accessible to computing device 210. For example, analysis module 220 may be an interface or application programming interface (API) to a remote server that analyzes source code files 224 and develops model 226.

In some examples, communication module 222 may execute locally (e.g., at processors 240) to provide functions associated with receiving explicit feedback and deriving implicit feedback from a user. In some examples, communication module 222 may act as an interface to a remote service accessible to computing device 210. For example, communication module 222 may be an interface or application programming interface (API) to a remote server that receives explicit feedback and implicit feedback from a user, the feedback acting as data to update model 226.

One or more storage components 248 within computing device 210 may store information for processing during operation of computing device 210 (e.g., computing device 210 may store data accessed by modules 220 and 222 during execution at computing device 210). In some examples, storage component 248 is a temporary memory, meaning that a primary purpose of storage component 248 is not long-term storage. Storage components 248 on computing device 210 may be configured for short-term storage of information as volatile memory and therefore not retain stored contents if powered off. Examples of volatile memories include random access memories (RAM), dynamic random access memories (DRAM), static random access memories (SRAM), and other forms of volatile memories known in the art.

Storage components 248, in some examples, also include one or more computer-readable storage media. Storage components 248 in some examples include one or more non-transitory computer-readable storage mediums. Storage components 248 may be configured to store larger amounts of information than typically stored by volatile memory. Storage components 248 may further be configured for long-term storage of information as non-volatile memory space and retain information after power on/off cycles. Examples of non-volatile memories include magnetic hard discs, optical discs, floppy discs, flash memories, or forms of electrically programmable memories (EPROM) or electrically erasable and programmable (EEPROM) memories. Storage components 248 may store program instructions and/or information (e.g., data) associated with modules 220 and 222, source code files 224, and model 226. Storage components 248 may include a memory configured to store data or other information associated with modules 220 and 222, source code files 224, and model 226.

Communication channels 250 may interconnect each of the components 212, 240, 242, 244, 246, and 248 for inter-component communications (physically, communicatively, and/or operatively). In some examples, communication channels 250 may include a system bus, a network connection, an inter-process communication data structure, or any other method for communicating data.

One or more communication units 242 of computing device 210 may communicate with external devices via one or more wired and/or wireless networks by transmitting and/or receiving network signals on one or more networks. Examples of communication units 242 include a network interface card (e.g., such as an Ethernet card), an optical transceiver, a radio frequency transceiver, a GPS receiver, a radio-frequency identification (RFID) transceiver, a near-field communication (NFC) transceiver, or any other type of device that can send and/or receive information. Other examples of communication units 242 may include short wave radios, cellular data radios, wireless network radios, as well as universal serial bus (USB) controllers.

One or more input components 244 of computing device 210 may receive input. Examples of input are tactile, audio, and video input. Input components 244 of computing device 210, in one example, include a presence-sensitive input device (e.g., a touch sensitive screen, a PSD), mouse, keyboard, voice responsive system, camera, microphone or any other type of device for detecting input from a human or machine. In some examples, input components 244 may include one or more sensor components (e.g., sensors 252). Sensors 252 may include one or more biometric sensors (e.g., fingerprint sensors, retina scanners, vocal input sensors/microphones, facial recognition sensors, cameras), one or more location sensors (e.g., GPS components, Wi-Fi components, cellular components), one or more temperature sensors, one or more movement sensors (e.g., accelerometers, gyros), one or more pressure sensors (e.g., barometer), one or more ambient light sensors, and one or more other sensors (e.g., infrared proximity sensor, hygrometer sensor, and the like). Other sensors, to name a few other non-limiting examples, may include a heart rate sensor, magnetometer, glucose sensor, olfactory sensor, compass sensor, or a step counter sensor.

One or more output components 246 of computing device 210 may generate output in a selected modality. Examples of modalities may include a tactile notification, audible notification, visual notification, machine generated voice notification, or other modalities. Output components 246 of computing device 210, in one example, include a presence-sensitive display, a sound card, a video graphics adapter card, a speaker, a cathode ray tube (CRT) monitor, a liquid crystal display (LCD), a light emitting diode (LED) display, an organic LED (OLED) display, a virtual/augmented/extended reality (VR/AR/XR) system, a three-dimensional display, or any other type of device for generating output to a human or machine in a selected modality.

UIC 212 of computing device 210 may include display component 202 and presence-sensitive input component 204. Display component 202 may be a screen, such as any of the displays or systems described with respect to output components 246, at which information (e.g., a visual indication) is displayed by UIC 212 while presence-sensitive input component 204 may detect an object at and/or near display component 202.

While illustrated as an internal component of computing device 210, UIC 212 may also represent an external component that shares a data path with computing device 210 for transmitting and/or receiving input and output. For instance, in one example, UIC 212 represents a built-in component of computing device 210 located within and physically connected to the external packaging of computing device 210 (e.g., a screen on a mobile phone). In another example, UIC 212 represents an external component of computing device 210 located outside and physically separated from the packaging or housing of computing device 210 (e.g., a monitor, a projector, etc. that shares a wired and/or wireless data path with computing device 210).

UIC 212 of computing device 210 may detect two-dimensional and/or three-dimensional gestures as input from a user of computing device 210. For instance, a sensor of UIC 212 may detect a user's movement (e.g., moving a hand, an arm, a pen, a stylus, a tactile object, etc.) within a threshold distance of the sensor of UIC 212. UIC 212 may determine a two or three-dimensional vector representation of the movement and correlate the vector representation to a gesture input (e.g., a hand-wave, a pinch, a clap, a pen stroke, etc.) that has multiple dimensions. In other words, UIC 212 can detect a multi-dimension gesture without requiring the user to gesture at or near a screen or surface at which UIC 212 outputs information for display. Instead, UIC 212 can detect a multi-dimensional gesture performed at or near a sensor which may or may not be located near the screen or surface at which UIC 212 outputs information for display.

In accordance with the techniques of this disclosure, communication module 222 may receive one or more source code files 224 and metadata for each of the one or more source code files 224. Analysis module 220 may identify, using model 226, one or more potential defects in a first source code file of the one or more source code files 224 based at least in part on one or more of source code saved in the first source code file and metadata for the first source code file. Each of the one or more potential defects may be an error that could potentially be realized if the first source code file were to be compiled or executed.

In some instances, model 226 may include multiple models separated by industry or any other classification (e.g., developer, developer experience, developer title, project within an industry, etc.). In such instances, analysis module 220 may determine an applicable industry (or other characteristic) for the one or more source code files 224, such as based on metadata descriptive of the one or more source code files 224. Analysis module 220 may select the particular model from the plurality of models based on the applicable industry, with the model including industry data associated with the applicable industry (or data associated with the particular classification). The industry data may include one or more of an identification of the applicable industry, a time-to-market expectation for the applicable industry, a bug quantity expectation for the applicable industry, a bug severity expectation for the applicable industry, and a project-level segmentation for the applicable industry.

In some examples, in identifying the one or more potential defects in the first source code file, analysis module 220 may perform static code analysis on the first source code file using model 226. For instance, analysis module 220 may parse the source code saved in the first source code file and the metadata for the first source code file to derive input data. The input data may include any one or more of an issue trace, a defect message, source information, sink information, a decision graph, an abstract syntax tree, environmental context, a time taken to correct an error, a correlation between a bug tracking system and a ticket system, an amount of time the source code was reviewed, source code comments, user textual description, co-pilot suggestions, a code author profile, reported defect metrics, code commits metrics, user behavior data, and the source code saved in the first source code file. Analysis module 220 may input the input data into model 226 to determine the one or more potential defects in the first source code file.

Communication module 222 may receive both explicit feedback and implicit feedback for the one or more potential defects. The explicit feedback may include any one or more of a defect status, usage data, user-identified defects, star factors, file metrics, method metrics, natural language processing on trace information, and third-party feedback. In receiving the explicit feedback as the defect status, communication module 220 may receive an indication of user input citing the defect status for a first potential defect of the one or more potential defects, where the defect status indicates one or more of a validity of the first potential defect, an urgency of the first potential defect, and a difficulty to fix the first potential defect.

In some instances, the implicit feedback may include any one or more of an indication of one of the one or more potential defects being fixed, a speed at which one of the one or more potential defects was corrected, an insertion of a code comment, a role of a particular developer, a developer history for the particular developer, an evolution of one of the one or more potential defects in future analyses, and a time of day at which the one of the potential defects was corrected. In receiving the implicit feedback, communication module 222 may monitor user behavior while the user is updating or interacting with the source code files and derive the implicit feedback from the monitored behavior.

Analysis module 220 may update the model with both the explicit feedback and the implicit feedback to develop an updated model. After updating the model, communication module 222 may receive a second set of one or more source code files and metadata for each source code file of the second set of one or more source code files. Analysis module 220 may identify one or more potential defects in a second source code file of the second set of one or more source code files based at least in part on one or more of source code saved in the second source code file and metadata for the second source code file using the updated model.

In some instances, model 226 may include a plurality of dynamic weights for each of a plurality of potential defects defined in the model. In such instances, in updating model 226 to determine the updated model, analysis module 220 may update one or more of the plurality of dynamic weights. Additionally or alternatively, analysis module 220 may add a new dynamic weight for a newly defined defect into the plurality of dynamic weights.

In some instances, in updating model 226 to determine the updated model, communication module 222 may retrieve online data indicating a global update to the model (e.g., an update to each model that utilizes the techniques described herein, or each model under a particular industry or developer classification). Analysis module 220 may update model 226 based on the explicit feedback, the implicit feedback, and the online data. The online data may include defect identification information shared by a third-party.

In some instances, analysis module 220 may determine, based on the one or more potential defects in the first source code file, additional output data. This additional output data may include any one or more of a ranking for each of the one or more potential defects, an indication of a validity of one of the one or more potential defects, a dynamic ranking for the one or more potential defects as a user corrects the source code in the first source code file, an indication of similar issues across an industry profile, a user profile, a codebase profile, a project profile, an overall project quality, a release quality, a developer ranking, a developer value, an estimated time to fix remaining defects, a development team value, a development cost for the source code in the first source code file, an end user feedback quality estimate, a developer happiness estimate, an estimate of company revenue, and an estimate of developer salary. Communication module 222 may output, for display on display component 202, a graphical indication of at least a portion of the additional output data.

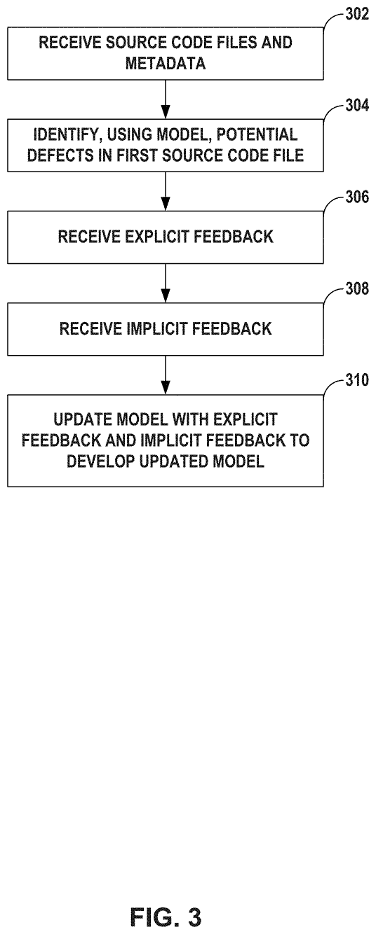

FIG. 3 is a flow chart illustrating an example mode of operation. The techniques of FIG. 3 may be performed by one or more processors of a computing device, such as system 100 of FIG. 1 and/or computing device 210 illustrated in FIG. 2. For purposes of illustration only, the techniques of FIG. 3 are described within the context of computing device 210 of FIG. 2, although computing devices having configurations different than that of computing device 210 may perform the techniques of FIG. 3.

In accordance with the techniques described herein, communication module 222 receives one or more source code files 224 and metadata for each of the one or more source code files 224, either by receiving them from an external storage component or retrieving them from an internal storage component (302). Analysis module 220 identifies, using model 226, one or more potential defects in a first source code file of source code files 224 based at least in part on one or more of source code saved in the first source code file and metadata for the first source code file (304). Communication module 222 receives both explicit feedback (306) and implicit feedback (308) for the one or more potential defects. Analysis module 220 updates model 226 with both the explicit feedback and the implicit feedback to develop an updated version of model 226 (310).

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples of the disclosure have been described. Any combination of the described systems, operations, or functions is contemplated. These and other examples are within the scope of the following claims.

What is claimed is:

1. A method comprising:
receiving, by one or more processors, one or more source code files and metadata for each of the one or more source code files;
identifying, by the one or more processors and using a model, one or more potential defects in a first source code file of the one or more source code files based at least in part on one or more of source code saved in the first source code file and metadata for the first source code file;
receiving, by the one or more processors, at least one of explicit feedback and implicit feedback for the one or more potential defects; and
updating, by the one or more processors, the model with the at least one of the explicit feedback and the implicit feedback to develop an updated model.

2. The method of claim 1, wherein receiving, by the one or more processors, at least one of explicit feedback and implicit feedback for the one or more potential defects comprises receiving, by the one or more processors, both explicit feedback and implicit feedback for the one or more potential defects.

3. The method of claim 1, further comprising:
receiving, by the one or more processors, a second set of one or more source code files and metadata for each source code file of the second set of one or more source code files; and
identifying, by the one or more processors and using the updated model, one or more potential defects in a second source code file of the second set of one or more source code files based at least in part on one or more of source code saved in the second source code file and metadata for the second source code file.

4. The method of claim 1, wherein the explicit feedback comprises one or more of:
a defect status,
usage data,
user-identified defects,
star factors,
file metrics,
method metrics,
natural language processing on trace information, and
third-party feedback.

5. The method of claim 4, wherein receiving the explicit feedback as the defect status comprises:
receiving, by the one or more processors, an indication of user input citing the defect status for a first potential defect of the one or more potential defects, wherein the defect status indicates one or more of a validity of the first potential defect, an urgency of the first potential defect, and a difficulty to fix the first potential defect.

6. The method of claim 1, wherein the implicit feedback comprises one or more of:
an indication of one of the one or more potential defects being fixed,
a speed at which one of the one or more potential defects was corrected,
an insertion of a code comment,
a role of a particular developer,
a developer history for the particular developer,
an evolution of one of the one or more potential defects in future analyses, and
a time of day at which the one of the potential defects was corrected.

7. The method of claim 1, further comprising:
determining, by the one or more processors, an applicable industry for the one or more source code files; and
selecting, by the one or more processors, the model from a plurality of models based on the applicable industry.

8. The method of claim 7, wherein the model includes industry data associated with the applicable industry.

9. The method of claim 8, wherein the industry data comprises one or more of:
an identification of the applicable industry,
a time-to-market expectation for the applicable industry,
a bug quantity expectation for the applicable industry,
a bug severity expectation for the applicable industry, and
a project-level segmentation for the applicable industry.

10. The method of claim 1, wherein the model comprises a plurality of dynamic weights for each of a plurality of potential defects defined in the model, and
wherein updating the model to determine the updated model comprises one or more of:
updating, by the one or more processors, one or more of the plurality of dynamic weights; and
adding, by the one or more processors, a new dynamic weight for a newly defined defect into the plurality of dynamic weights.

11. The method of claim 1, wherein updating the model to determine the updated model further comprises:
retrieving, by the one or more processors, online data indicating a global update to the model; and
updating, by the one or more processors, the model based on the explicit feedback, the implicit feedback, and the online data.

12. The method of claim 11, wherein the online data comprises defect identification information shared by a third-party.

13. The method of claim 1, wherein each of the one or more potential defects comprise an error that could potentially be realized if the first source code file were to be compiled or executed.

14. The method of claim 1, wherein identifying the one or more potential defects in the first source code file comprises performing static code analysis on the first source code file using the model.

15. The method of claim 14, wherein performing the static code analysis on the first source code file comprises:
parsing, by the one or more processors, the source code saved in the first source code file and the metadata for the first source code file to derive input data; and
inputting, by the one or more processors, the input data into the model to determine the one or more potential defects in the first source code file.

16. The method of claim 15, wherein the input data comprises one or more of:
an issue trace,
a defect message,
source information,
sink information,
a decision graph,
an abstract syntax tree,
environmental context,
a time taken to correct an error,
a correlation between a bug tracking system and a ticket system,
an amount of time the source code was reviewed,
source code comments,
user textual description,
co-pilot suggestions,
a code author profile,
reported defect metrics,
code commits metrics,
user behavior data, and
the source code saved in the first source code file.

17. The method of claim 1, further comprising:
determining, by the one or more processors and based on the one or more potential defects in the first source code file, additional output data; and
outputting, by the one or more processors and for display on a display device, a graphical indication of at least a portion of the additional output data.

18. The method of claim 17, wherein the additional output data comprises one or more of:
a ranking for each of the one or more potential defects,
an indication of a validity of one of the one or more potential defects,
a dynamic ranking for the one or more potential defects as a user corrects the source code in the first source code file,
an indication of similar issues across an industry profile, a user profile, a codebase profile, and/or a project profile,
an overall project quality,
a release quality,
a developer ranking,
a developer value,
an estimated time to fix remaining defects,
a development team value,
a development cost for the source code in the first source code file,
an end user feedback quality estimate,
a developer happiness estimate,
an estimate of company revenue, and
an estimate of developer salary.

19. A computing device comprising:
one or more storage components configured to store a model and one or more source code files; and
one or more processors configured to:
retrieve the one or more source code files and metadata for each of the one or more source code files from the one or more storage components;
identify, using the model, one or more potential defects in a first source code file of the one or more source code files based at least in part on one or more of source code saved in the first source code file and metadata for the first source code file;
receive at least one of explicit feedback and implicit feedback for the one or more potential defects; and
update the model with the at least one of the explicit feedback and the implicit feedback to develop an updated model.

20. The computing device of claim 19, wherein the one or more processors are further configured to:
retrieve a second set of one or more source code files and metadata for each source code file of the second set of one or more source code files from the one or more storage components; and
identify, using the updated model, one or more potential defects in a second source code file of the second set of one or more source code files based at least in part on one or more of source code saved in the second source code file and metadata for the second source code file.

21. A non-transitory computer-readable storage medium comprising instructions that, when executed by one or more processors of a computing device, cause the one or more processors to:
receive one or more source code files and metadata for each of the one or more source code files;
identify, using a model, one or more potential defects in a first source code file of the one or more source code files based at least in part on one or more of source code saved in the first source code file and metadata for the first source code file;
receive at least one of explicit feedback and implicit feedback for the one or more potential defects; and
update the model with the at least one of the explicit feedback and the implicit feedback to develop an updated model.
